(19) United States
(12) Patent Application Publication
(10) Pub. No.: US 2014/0314038 A1
(43) Pub. Date: Oct. 23, 2014

(54) METHOD AND APPARATUS FOR TRANSMITTING CONTROL INFORMATION IN A WIRELESS COMMUNICATION SYSTEM

(71) Applicant: LG ELECTRONICS INC., Seoul (KR)

(72) Inventors: Inkwon Seo, Anyang-si (KR); Hanbyul Seo, Anyang-si (KR); Hakseong Kim, Anyang-si (KR)

(73) Assignee: LG Electronics Inc., Seoul (KR)

(21) Appl. No.: 14/358,177

(22) PCT Filed: Nov. 15, 2012
(86) PCT No.: PCT/KR2012/009646

§ 371 Date: May 14, 2014

Related U.S. Application Data
(60) Provisional application No. 61/560,768, filed on Nov. 16, 2011.
(60) Provisional application No. 61/641,908, filed on May 3, 2012.

(51) Int. Cl. H04W 74/00

(52) U.S. Cl. CPC H04W 74/006
USPC 370/329

(57) ABSTRACT

The present invention relates to a method for transmitting control information by a base station in a wireless communication system, and includes a step of transmitting an enhanced physical downlink channel (EPDCCH) for a terminal using at least one physical resource block pair from among a plurality of physical resource block pairs. The plurality of physical resource block pairs include a plurality of resource units for the EPDCCH transmission to which an antenna port is allocated, respectively. When the EPDCCH for a terminal is transmitted using at least two resource units from among the at least one physical resource block pairs, the same pre-coding is applied to signals to be transmitted via at least two resource units.

### TECHNICAL FIELD

The present invention relates to a wireless communication system and, more particularly, to a method and apparatus for transmitting an enhanced physical downlink channel (EPDCCH).

### BACKGROUND ART

Wireless communication systems have been widely deployed in order to provide various types of communication services such as voice or data services. Generally, a wireless communication system is a multiple access system capable of supporting communication with multiple users by sharing available system resources (bandwidth, transmit power, etc.). Multiple access systems include, for example, a code division multiple access (CDMA) system, a frequency division multiple access (FDMA) system, a time division multiple access (TDMA) system, an orthogonal frequency division multiple access (OFDMA) system, a single-carrier frequency division multiple access (SC-FDMA) system, and a multi-carrier frequency division multiple access (MC-FDMA) system.

### DISCLOSURE

### Technical Problem

The present invention discloses embodiments associated with the application of the same precoding to a prescribed resource unit for EPDCCH transmission in transmitting control information.

The technical objects that can be achieved through the present invention are not limited to what has been particularly described hereinabove and other technical objects not described herein will be more clearly understood by persons skilled in the art from the following detailed description.

### Technical Solution

In a first technical aspect of the present invention, provided herein is a method for transmitting control information by a base station in a wireless communication system, the method including transmitting an enhanced physical downlink channel (EPDCCH) for a user equipment using at least one or more physical resource block (PRB) pairs among a plurality of PRB pairs for EPDCCH transmission, wherein the plural PRB pairs includes a plurality of resource units for EPDCCH transmission, to which antenna ports are respectively allocated, and if the EPDCCH for the user equipment is transmitted using at least two or more resource units in the at least one or more PRB pairs, the same precoding is applied to signals to be transmitted in the two or more resource units.

In a second aspect of the present invention, provided herein is a base station in a wireless communication system, the base station including a transmission module; and a processor, wherein the processor transmits an enhanced physical downlink channel (EPDCCH) for a user equipment using at least one or more physical resource block (PRB) pairs among a plurality of PRB pairs for EPDCCH transmission, the plural PRB pairs includes a plurality of resource units for EPDCCH transmission, to which antenna ports are respectively allocated, and if the EPDCCH for the user equipment is transmitted using at least two or more resource units in the at least one or more PRB pairs, the same precoding is applied to signals to be transmitted in the two or more resource units.

The first and second technical aspects of the present invention may include the following.

The at least two or more resource units in which the EPDCCH for the UE is transmitted may be included in one PRB pair and different antenna ports may be allocated to the at least two or more resource units.

The at least two or more resource units included in the one PRB pair may be for one downlink control information (DCI). The number of resource units in which the EPDCCH for the user equipment is transmitted may be determined according to an aggregation level. If the number of resource units in which the EPDCCH for the user equipment is transmitted is greater than a preset number, the base station may apply precoding unique to each signal to be transmitted in resource units of the preset number or more. Only one of the different antenna ports may be used for channel estimation of the user equipment. If all of the different antenna ports are used for channel estimation of the user equipment, channel estimation may be performed by an average of channel estimation values for the different antenna ports. If all of the different antenna ports are used for channel estimation of the user equipment, all of demodulation reference signal reference elements related respectively to the different antenna ports may be used for channel estimation.

The at least two or more resource units in which the EPDCCH for the user equipment is transmitted may be included in different PRB pairs and different antenna ports may be allocated to the at least two or more resource units. The at least two or more resource units included in the different PRB pairs may be for at least two or more pieces of downlink control information (DCI). The at least two or more pieces of DCI may include DCI for uplink information transmission and DCI for downlink information transmission. If the different PRB pairs are separated by a preset value or more in a frequency domain, the base station may apply precoding unique to each signal to be transmitted in two or more resource units. Only one of the different antenna ports may be used for channel estimation of the user equipment. If all of the different antenna ports are used for channel estimation of the user equipment, channel estimation may be performed by an average of channel estimation values of the different antenna ports. If all of the different antenna ports are used for channel estimation of the user equipment, all of demodulation reference signal reference elements related respectively to the different antenna ports may be used for channel estimation.

Signaling indicating whether to apply the same precoding may be transmitted to the user equipment through higher layer signaling.

A resource unit for EPDCCH transmission may be an enhanced control channel element (eCCE).

### Advantageous Effects

According to the present invention, transmission of control information can be performed while increasing efficiency of channel estimation.

Effects according to the present invention are not limited to what has been particularly described hereinabove and other advantages not described herein will be more clearly understood by persons skilled in the art from the following detailed description of the present invention.

### DESCRIPTION OF DRAWINGS

The accompanying drawings, which are included to provide a further understanding of the invention, illustrate embodiments of the invention and together with the description serve to explain the principle of the invention.

FIG. 1 is a view illustrating the structure of a radio frame.

FIG. 2 is a view illustrating a resource grid in a downlink slot.

FIG. 3 is a view illustrating the structure of a downlink subframe.

FIG. 4 is a view illustrating the structure of an uplink subframe.

FIG. 5 is a view for explaining a search space.

FIG. 6 is a view for explaining reference signals.

FIGS. 7 and 8 are views for explaining demodulation reference signals.

FIGS. 9 and 10 are views for explaining embodiments of the present invention.

FIG. 11 is a view illustrating transmitting and receiving devices.

### BEST MODE FOR CARRYING OUT THE INVENTION

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or features of any one embodiment may be included in another embodiment and may be replaced with corresponding constructions or features of another embodiment.

In the present disclosure, the embodiments of the present invention are described based on a data transmission and reception relationship between a base station (BS) and a terminal. The BS is a terminal node of a network, which directly communicates with the terminal. A specific operation described as performed by the BS may be performed by an upper node of the BS.

In other words, it is apparent that, in a network comprised of a plurality of network nodes including a BS, various operations performed for communication with a terminal may be performed by the BS, or network nodes other than the BS. The term BS may be replaced with the terms fixed station, Node B, evolved Node B (eNode B or eNB), access point (AP), transmission point, etc. The term relay is used interchangeably with the terms relay node (RN), relay station (RS), etc. The term terminal may be replaced with the terms user equipment (UE), mobile station (MS), mobile subscriber station (MSS), subscriber station (SS), etc.

Specific terms used in the following description are provided to aid in understanding of the present invention. These specific terms may be replaced with other terms within the scope and spirit of the present invention.

In some cases, to prevent the concept of the present invention from being ambiguous, structures and apparatuses of the known art will be omitted, or will be shown in the form of a block diagram based on main functions of each structure and apparatus. In addition, wherever possible, the same reference numbers will be used throughout the drawings and the specification to refer to the same or like parts.

The embodiments of the present invention can be supported by standard documents disclosed for at least one of wireless access systems such as the institute of electrical and electronics engineers (IEEE) 802, 3^{rd} generation partnership project (3GPP), 3GPP long term evolution (3GPP LTE), LTE-advanced (LTE-A), and 3GPP2 systems. For steps or parts, description of which is omitted to clarify the technical features of the present invention, reference may be made to these documents. Further, all terms as set forth herein can be explained by the standard documents.

The following technology can be used in various wireless access systems such as systems for code division multiple access (CDMA), frequency division multiple access (FDMA), time division multiple access (TDMA), orthogonal frequency division multiple access (OFDMA), single carrier frequency division multiple access (SC-FDMA), etc. CDMA may be implemented by radio technology such as universal terrestrial radio access (UTRA) or CDMA2000. TDMA may be implemented by radio technology such as global system for mobile communications (GSM)/general packet radio service (GPRS)/enhanced data rates for GSM evolution (EDGE). OFDMA may be implemented by radio technology such as IEEE 802.11 (Wi-Fi), IEEE 802.16 (WiMAX), IEEE 802.20, evolved-UTRA (E-UTRA), etc. UTRA is a part of universal mobile telecommunication system (UMTS). 3GPP LTE is a part of evolved-UMTS (E-UMTS) using E-UTRA. 3GPP LTE employs OFDMA for downlink and SC-FDMA for uplink. LTE-A is an evolution of 3GPP LTE. WiMAX can be explained by the IEEE 802.16e specification (wireless metropolitan area network (WirelessMAN)-OFDMA reference system) and the IEEE 802.16m specification (WirelessMAN-OFDMA advanced system). For clarity, the present disclosure focuses on 3GPP LTE and LTE-A systems. However, the technical features of the present invention are not limited thereto.

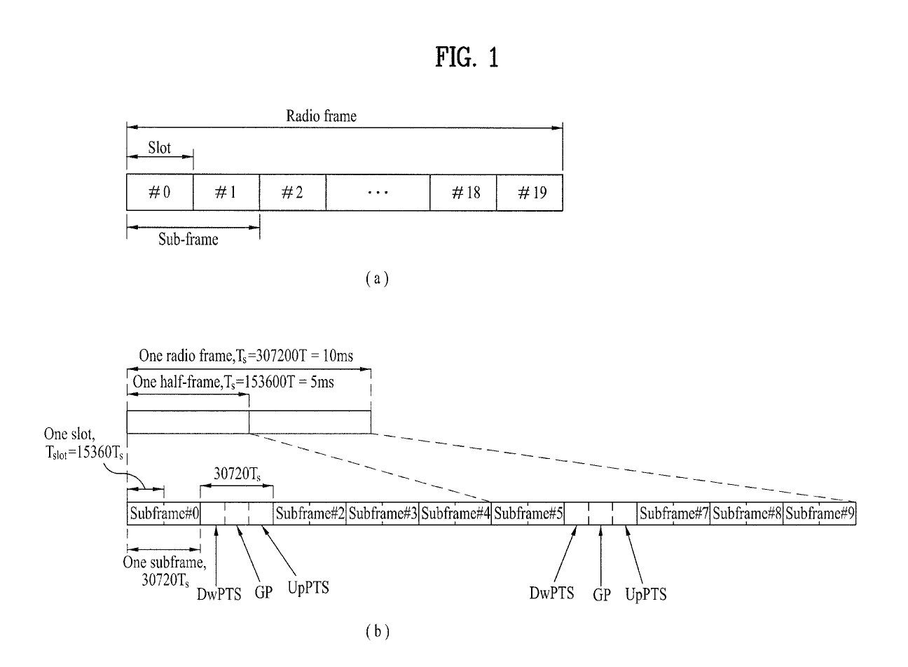

The structure of a radio frame will now be described with reference to FIG. 1.

In a cellular orthogonal frequency division multiplexing (OFDM) wireless packet communication system, uplink (UL)/downlink (DL) data packets are transmitted in units of subframes. One subframe is defined as a predetermined time period including a plurality of OFDM symbols. 3GPP LTE supports the structure of a type 1 radio frame applicable to frequency division duplex (FDD) and the structure of a type 2 radio frame applicable to time division duplex (TDD).

FIG. 1(a) is a diagram illustrating the structure of the type 1 radio frame. A DL radio frame is divided into 10 subframes each including two slots in the time domain. A time during which one subframe is transmitted is defined as a transmission time interval (TTI). For example, one subframe may be 1 ms long and one slot may be 0.5 ms long. One slot includes a plurality of OFDM symbols in the time domain and a plurality of resource blocks (RBs) in the frequency domain. Since the 3GPP LTE system uses OFDMA on DL, an OFDM symbol is one symbol period. The OFDM symbol may be called an SC-FDMA symbol or symbol period. An RB is a resource allocation unit including a plurality of contiguous subcarriers in one slot.

The number of OFDM symbols included in one slot may be changed according to the configuration of a cyclic prefix (CP). There are two types of CPs, extended CP and normal CP. For example, if each OFDM symbol is configured to include a normal CP, one slot may include 7 OFDM symbols. If each OFDM symbol is configured to include an extended CP, the length of an OFDM symbol is increased and thus the number of OFDM symbols included in one slot is less than that in the case of a normal CP. In the case of the extended CP, for example, one slot may include 6 OFDM symbols. If a channel state is unstable, as is the case when a UE moves fast, the extended CP may be used in order to further reduce inter-symbol interference.

In the case of the normal CP, since one slot includes 7 OFDM symbols, one subframe includes 14 OFDM symbols. The first two or three OFDM symbols of each subframe may be allocated to a physical downlink control channel (PDCCH) and the remaining OFDM symbols may be allocated to a physical downlink shared channel (PDSCH).

FIG. 1(b) illustrates the structure of the type 2 radio frame. The type 2 radio frame includes two half frames, each half frame including 5 subframes, a DL pilot time slot (DwPTS), a guard period (GP), and a UL pilot time slot (UpPTS). One subframe is divided into two slots. The DwPTS is used for initial cell search, synchronization, or channel estimation at a UE, and the UpPTS is used for channel estimation and UL transmission synchronization with a UE at an eNB. The GP is used to cancel UL interference between UL and DL, caused by the multi-path delay of a DL signal. One subframe includes two slots irrespective of the type of a radio frame.

The structures of radio frames are only exemplary. Accordingly, the number of subframes in a radio frame, the number of slots in a subframe, and the number of symbols in a slot may be changed in various manners.

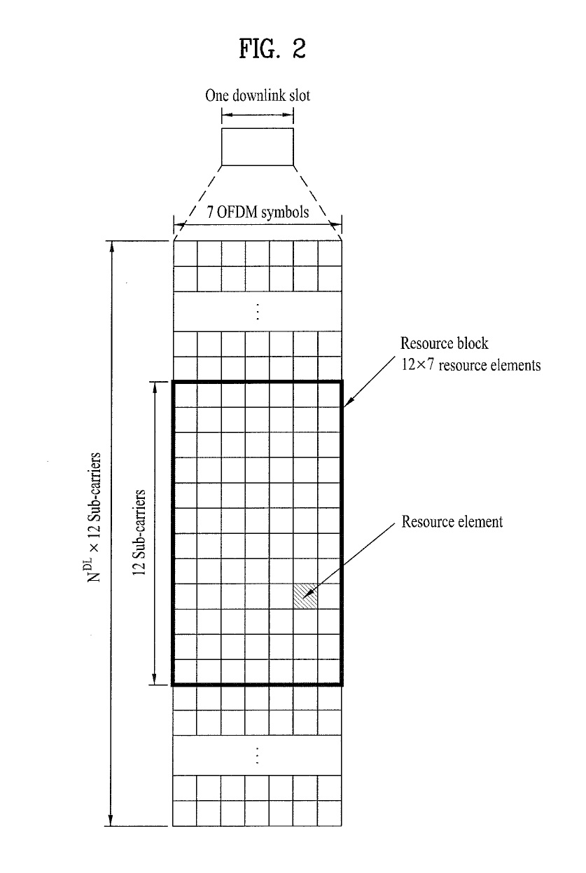

FIG. 2 illustrates a resource grid in a DL slot. A DL slot has 7 OFDM symbols in the time domain and an RB includes 12 subcarriers in the frequency domain, which does not limit the present invention. For example, a DL slot includes 7 OFDM symbols in a subframe with normal CPs, whereas a DL slot includes 6 OFDM symbols in a subframe with extended CPs. Each element of the resource grid is referred to as a resource element (RE). An RB includes 12×7 REs. The number of RBs in a DL slot, N^{DL}, depends on a DL transmission bandwidth. A UL slot may have the same structure as a DL slot.

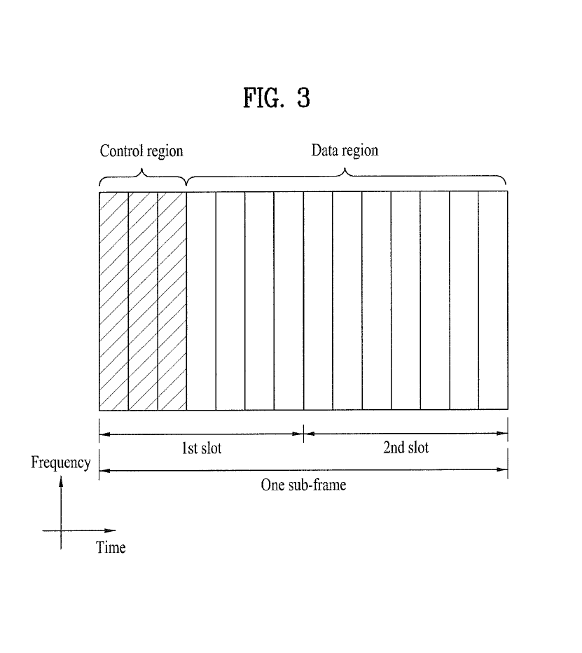

FIG. 3 is a diagram illustrating the structure of a DL subframe. Up to three OFDM symbols at the start of the first slot of a DL subframe are used as a control region to which control channels are allocated and the other OFDM symbols of the DL subframe are used as a data region to which a PDSCH is allocated. DL control channels used in the 3GPP LTE system include a physical control format indicator channel (PCFICH), a physical downlink control channel (PDCCH), and a physical hybrid automatic repeat request (HARQ) indicator channel (PHICH). The PCFICH is located in the first OFDM symbol of a subframe, carrying information about the number of OFDM symbols used for transmission of control channels in the subframe. The PHICH delivers a HARQ acknowledgment/negative acknowledgment (ACK/NACK) signal as a response to a UL transmission. Control information carried on the PDCCH is called downlink control information (DCI). The DCI includes UL scheduling information, DL scheduling information, or UL transmit power control commands for UE groups. The PDCCH delivers information about resource allocation and a transport format for a downlink shared channel (DL-SCH), resource allocation information about an uplink shared channel (UL-SCH), paging information of a paging channel (PCH), system information on the DL-SCH, information about resource allocation for a higher-layer control message such as a random access response transmitted on the PDSCH, a set of transmit power control commands for individual UEs of a UE group, transmit power control information, voice over Internet protocol (VoIP) activation information, etc. A plurality of PDCCHs may be transmitted in the control region. A UE may monitor a plurality of PDCCHs. A PDCCH is formed by aggregating one or more consecutive control channel elements (CCEs). A CCE is a logical allocation unit used to provide a PDCCH at a coding rate based on the state of a radio channel. A CCE includes a plurality of resource element groups. The format of a PDCCH and the number of available bits for the PDCCH are determined according to the relationship between the number of CCEs and a coding rate provided by the CCEs. An eNB determines a PDCCH format according to DCI transmitted to a UE and adds a cyclic redundancy check (CRC) to control information. The CRC is masked by an identifier (ID) known as a Radio Network Temporary Identifier (RNTI) according to the owner or usage of the PDCCH. If the PDCCH is destined for a specific UE, the CRC may be masked by a cell-RNTI (C-RNTI) of the UE. If the PDCCH carries a paging message, the CRC thereof may be masked by a paging indicator identifier (P-RNTI). If the PDCCH carries system information (more particularly, a system information block (SIB)), the CRC thereof may be masked by a system information ID and a system information RNTI (SI-RNTI). To indicate that the PDCCH carries a random access response to a random access preamble transmitted by a UE, the CRC thereof may be masked by a random access-RNTI (RA-RNTI).

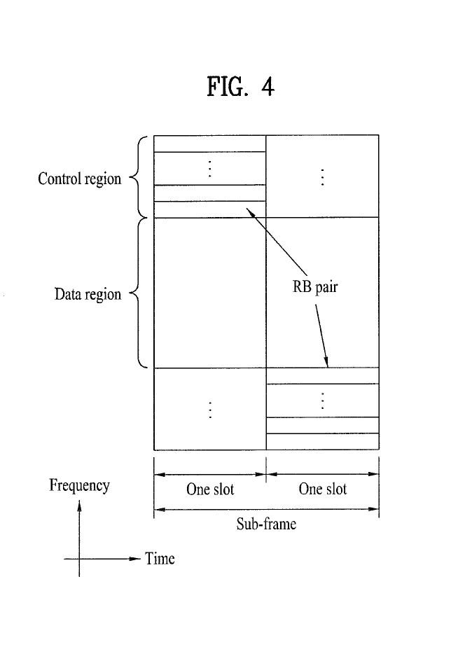

FIG. 4 is a diagram illustrating the structure of a UL subframe. The UL subframe is divided into a control region and a data region in the frequency domain. A physical uplink control channel (PUCCH) including uplink control information (UCI) is allocated to the control region and a physical uplink shared channel (PUSCH) including user data is allocated to the data region. To maintain single-carrier properties, a UE does not transmit a PUSCH and a PUCCH simultaneously. A PUCCH for one UE is allocated to an RB pair in a subframe. The RBs belonging to the RB pair occupy different subcarriers in two slots. Thus it is said that the RB pair allocated to the PUCCH is frequency-hopped over a slot boundary.

### DCI Formats

Current LTE-A (release 10) defines DCI formats 0, 1, 1A, 1B, 1C, 1D, 2, 2A, 2B, 2C, 3, 3A, and 4. DCI formats 0, 1A, 3, and 3A have the same message size to reduce the number of blind decoding procedures as described later. According to the usages of control information transmitted in these DCI formats, the DCI formats are classified into i) DCI formats 0 and 4 used for a UL grant, ii) DCI formats 1, 1A, 1B, 1C, 1D, 2, 2A, 2B, and 2C used for DL scheduling assignment, and iii) DCI formats 3 and 3A used for transmit power control (TPC) commands.

DCI format 0 used for transmission of a UL grant may include a carrier indicator required for later-described carrier aggregation, an offset that differentiates DCI format 0 from DCI format 1A (flag for format 0/format 1A differentiation), a frequency hopping flag indicating whether frequency hopping applies to UL PUSCH transmission, resource block assignment information about allocation of RBs to PUSCH transmission of a UE, a modulation and coding scheme (MCS), a new data indicator used to empty a buffer for initial transmission in relation to a HARQ process, a TPC command for a scheduled PUSCH, cyclic shift for a DMRS and an orthogonal cover code (OCC) index, a UL index required for time division duplexing (TDD) operation, and channel quality indicator (CQI) request (or channel state information (CSI) request) information. Because DCI format 0 uses synchronous HARQ, DCI format 0 does not include a redundancy version, compared to DCI formats related to DL scheduling assignment. If cross carrier scheduling is not used, the carrier indicator is not included in the DCI format.

DCI format 4 has been newly added to LTE-A release 10, with the aim to support spatial multiplexing for UL transmission. Compared to DCI format 0, DCI format 4 further includes spatial multiplexing information, thus having a relatively large message size. In addition to control information included in DCI format 0, DCI format 4 further includes other control information. That is, DCI format 4 further includes an MCS for a second transport block, precoding information for multiple input multiple output (MIMO) transmission, and sounding reference signal (SRS) request information. Because DCI format 4 is greater than DCI format 0 in size, DCI format 4 does not include the flag for format 0/format 1A differentiation.

Among DCI formats 1, 1A, 1B, 1C, 1D, 2, 2A, 2B, and 2C related to DL scheduling assignment, DCI formats 1, 1A, 1B, 1C, and 1D do not support spatial multiplexing, whereas DCI formats 2, 2A, 2B, and 2C support spatial multiplexing.

DCI format 1C supports only contiguous frequency allocation for compact DL assignment. Compared to other DCI formats, DCI format 1C does not include the carrier offset and the redundancy version.

DCI format 1A is used for DL scheduling and a random access procedure. DCI format 1A may include a carrier indicator, an indicator indicating whether distributed DL transmission is used, PDSCH resource allocation information, an MCS, a redundancy version, a HARQ process number indicating a processor used for soft combining, a new data indicator used to empty a buffer for initial transmission in relation to a HARQ process, a TPC command for a PUCCH, a UL index required for TDD operation, etc.

Control information of DCI format 1 is mostly similar to control information of DCI format 1A except that DCI format 1A is related to contiguous resource allocation and DCI format 1 supports non-contiguous resource allocation. Accordingly, DCI format 1 further includes a resource allocation header, thereby increasing control signaling overhead as a trade-off for increase in resource allocation flexibility.

DCI formats 1B and 1D both further include precoding information, compared to DCI format 1. DCI format 1B includes precoding matrix index (PMI) confirmation and DCI format 1D carries DL power offset information. Other control information included in DCI formats 1B and 1D is mostly identical to control information of DCI format 1A.

DCI formats 2, 2A, 2B, and 2C basically include most of the control information included in DCI format 1A and further include spatial multiplexing information. The spatial multiplexing information includes an MCS for a second transport block, a new data indicator, and a redundancy version.

DCI format 2 supports closed-loop spatial multiplexing and DCI format 2A supports open-loop spatial multiplexing. Both DCI formats 2 and 2A include precoding information. DCI format 2B supports dual-layer spatial multiplexing combined with beamforming and further includes cyclic shift information for a DMRS. DCI format 2C is an extension of DCI format 2B, supporting spatial multiplexing of up to 8 layers.

DCI formats 3 and 3A may be used to support TPC information included in DCI formats used for transmission of a UL grant and DL scheduling assignment, that is, to support semi-persistent scheduling. A 1-bit command is used per UE in DCI format 3 and a 2-bit command is used per UE in DCI format 3A.

One of the above-described DCI formats may be transmitted on one PDCCH and a plurality of PDCCHs may be transmitted in the control region. A UE may monitor a plurality of PDCCHs.

### PDCCH Processing

CCEs, which are contiguous logical allocation units, are used to map PDCCHs to REs. One CCE includes a plurality of (e.g. 9) resource element groups (REGs), each REG having four adjacent REs except for RS REs.

The number of CCEs required for a specific PDCCH depends on DCI payload indicating control information size and on cell bandwidth, channel coding rate, etc. Specifically, the number of CCEs for a specific PDCCH may be defined according to a PDCCH format, as illustrated in Table 1.

TABLE 1

| PDCCH | Number of | Number of | Number of |
|---|---|---|---|
| format | CCEs | REGs | PDCCH bits |
| 0 | 1 | 9 | 72 |
| 1 | 2 | 18 | 144 |
| 2 | 4 | 36 | 288 |
| 3 | 8 | 72 | 576 |

As described before, one of the above four formats is used for a PDCCH, which is not known to a UE. Therefore, the UE should decode the PDCCH without knowledge of the PDCCH format. This is called blind decoding. However, because decoding of all possible DL CCEs for each PDCCH format may impose a great constraint on the UE, a search space is defined in consideration of scheduler restrictions and the number of decoding attempts.

Namely, a search space is a set of candidate PDCCHs formed by CCEs that the UE is supposed to attempt to decode at a given aggregation level. Aggregation levels and the number of PDCCH candidates may be defined as follows.

TABLE 2

| | Search space | | Number of PDCCH |
|---|---|---|---|
| | Aggregation level | Size (in CCEs) | candidates |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

As noted from Table 2, there are four aggregation levels and thus the UE has a plurality of search spaces at each aggregation level. Search spaces may be classified into a UE-specific search space and a common search space. The USS is configured for specific UEs. Each of the UEs may monitor the UE-specific search space (may attempt to decode a set of PDCCH candidates according to possible DCI formats) and verify an RNTI masked with a PDCCH and a CRC of the PDCCH. If the RNTI and CRC are valid, the UE may acquire control information.

The common search space is designed for the case in which a plurality of UEs or all UEs need to receive a PDCCH for dynamic scheduling of system information or a paging message. Nonetheless, the common search space may be used for a specific UE depending on resource management. The common search space may overlap with the UE-specific search space.

A search space may be determined by Equation 1.

L{(Yₖ+m′)mod └N_{CCE,k}/L┘}+i [Equation 3]

where L is an aggregation level, Yₖ is a variable determined by an RNTI and subframe number k, and m′ is the number of PDCCH candidates. If carrier aggregation is used, m′=m+M^{(L)}·n_{Cl} and otherwise, m′=m. Here, m=0, . . . , M^{(L)}−1 where M^{(L)} is the number of PDCCH candidates. N_{CCE,k} is the total number of CCEs in the control region of a k-th subframe and i indicates an individual CCE in a PDCCH candidate (i=0, . . . , L−1). In the common search space, Yₖ is always 0.

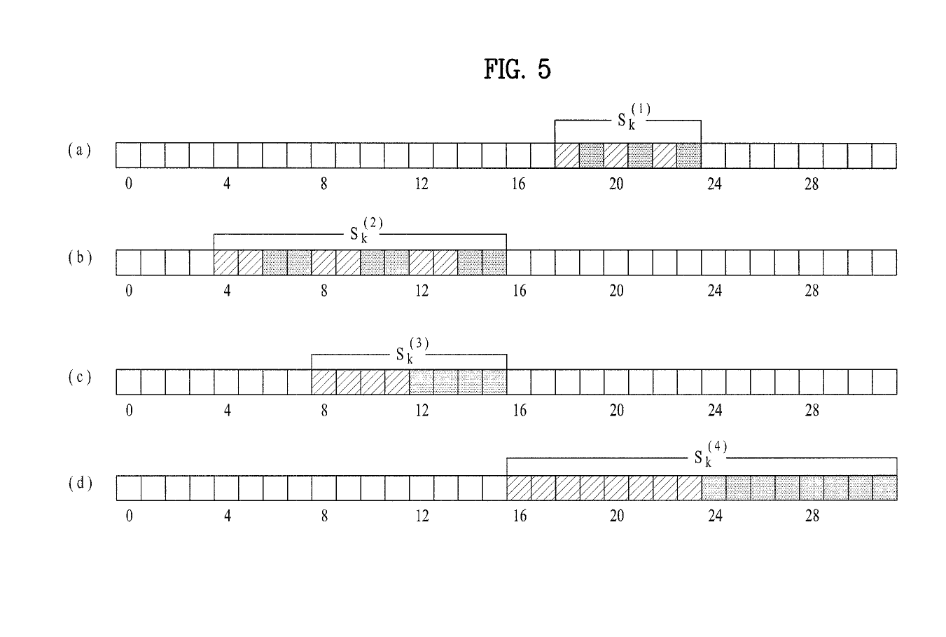

FIG. 5 illustrates a UE-specific search space (shaded) at each aggregation level, as defined by Equation 1. Here, carrier aggregation is not adopted and N_{CCE,k} is set to 32, for convenience of description.

FIGS. 5(a), 5(b), 5(c), and 5(d) illustrate UE-specific search spaces at aggregation levels 1, 2, 4, and 8, respectively. In FIG. 5, numbers indicate CCE numbers. As described before, the start CCE of a search space at each aggregation level is determined by an RNTI and subframe number k. For a UE, the start CCE of a search space may be different in the same subframe according to an aggregation level due to a modulo function and L. In addition, the start CCE of a search space is always a multiple of an aggregation level due to L. By way of example, Yₖ is CCE 18. The UE attempts to sequentially decode CCEs in units of CCEs determined by an aggregation level, starting from the start CCE. For example, (b) of FIG. 5, the UE attempts to decode CCEs in units of two CCEs according to an aggregation level, starting from CCE 4 which is the start CCE.

As described above, the UE attempts to perform decoding in a search space. The number of decoding procedures is determined by a DCI format and a transmission mode indicated by radio resource control (RRC) signaling. If carrier aggregation is not used, the UE needs to attempt a maximum of 12 decoding procedures in a common search space, in consideration of two DCI sizes (DCI format 0/1A/3/3A and DCI format 1C) for each of six PDCCH candidates. In a UE-specific search space, the UE needs to attempt a maximum of 32 decoding procedures, in consideration of two DCI sizes for each of 16 PDCCH candidates (6+6+2+2=16).

Meanwhile, if carrier aggregation is used, the maximum number of decoding procedures is further increased because as many decoding procedures as the number of DL resources (component carriers) are added for a UE-specific search space and DCI format 4.

### Reference Signal (RS)

In a wireless communication system, a packet is transmitted through a radio channel and thus the packet may be distorted during transmission. To receive a signal successfully, a receiver should compensate for the distortion of the received signal using channel information. To obtain the channel information, a transmitter transmits a signal known to both the transmitter the receiver and the receiver acquires the channel information based on the distortion of the signal received through the radio channel. This signal is called a pilot signal or an RS.

In the case of data transmission and reception using multiple antennas, channel states between transmit antennas and receive antennas should be discerned in order to correctly receive a signal. Accordingly, an RS should be transmitted through each transmit antenna, more specifically, each antenna port.

RSs may be divided into UL RSs and DL RSs. In the current LTE system, the UL RSs include:

i) Demodulation reference signal (DMRS) used for channel estimation for coherent demodulation of information transmitted through a PUSCH and a PUCCH; and

ii) Sounding reference signal (SRS) used for an eNB or a network to measure the quality of a UL channel in a different frequency.

The DL RSs include:

i) Cell-specific reference signal (CRS) shared among all UEs in a cell;

ii) UE-specific RS dedicated to a specific UE;

iii) DM-RS used for coherent demodulation when a PDSCH is transmitted;

iv) Channel State Information-Reference Signal (CSI-RS) used for transmitting CSI, when DL DM-RSs are transmitted;

v) Multimedia broadcast single frequency network (MBSFN) RS used for coherent demodulation of a signal transmitted in MBSFN mode; and

vi) Positioning RS used to estimate geographic position information of a UE.

RSs may be divided into two types according to purposes thereof: RSs for channel information acquisition and RSs for data demodulation. Since the purpose of the former is to cause the UE to acquire DCI, the RSs for channel information acquisition should be transmitted in a broad band and a UE that does not receive DL data in a specific subframe should receive the RSs. The RSs for channel information acquisition are also used in a situation such as handover. The RSs for data demodulation are RSs that are transmitted by an eNB to a corresponding resource together with DL data. A UE can demodulate the data by measuring a channel using the RSs for data demodulation. The RSs for data demodulation should be transmitted in a data transmission area.

The CRS is used for two purposes, that is, channel information acquisition and data demodulation. The UE-specific RS is used only for data demodulation. The CRS is transmitted in every subframe in a broad band and CRSs for up to four antenna ports are transmitted according to the number of transmit antennas of an eNB.

For example, if the number of transmit antennas of an eNB is 2, CRSs for antenna ports 0 and 1 are transmitted. In the case of four transmit antennas, CRSs for antenna ports 0 to 3 are respectively transmitted.

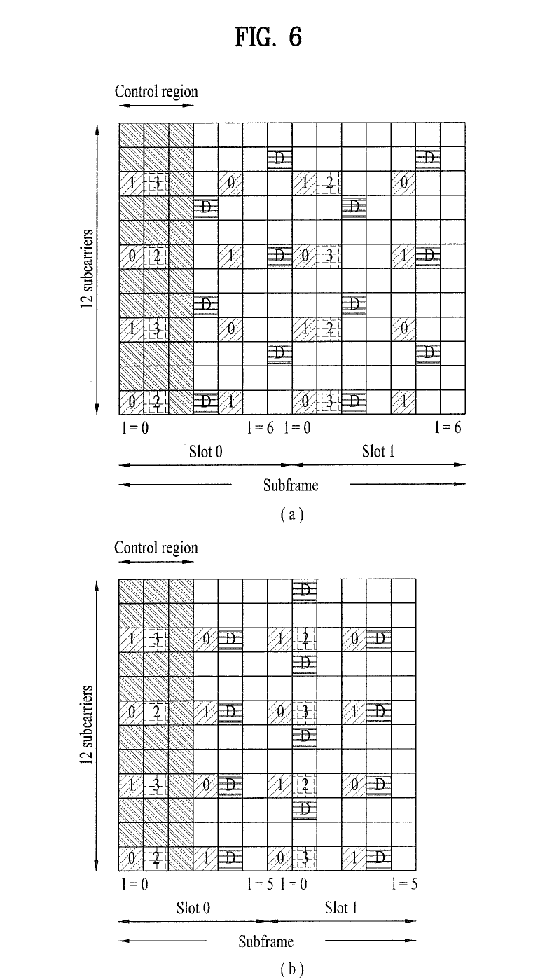

FIG. 6 illustrates patterns in which CRSs and DRSs are mapped to a DL RB pair, as defined in a legacy 3GPP LTE system (e.g. a Release-8 system). A DL RB pair as an RS mapping unit may be expressed as one subframe in time by 12 subcarriers in frequency. That is, an RB pair includes 14 OFDM symbols in the time domain in the case of the normal CP (see FIG. 5(a)) and 12 OFDM symbols in the time domain in the case of the extended CP (FIG. 6(b)).

FIG. 6 illustrates the positions of RSs on an RB pair in a system where an eNB supports four transmit antennas. In FIG. 5, REs expressed by reference numerals ‘0’, ‘1’, ‘2’, and ‘3’ illustrates the positions of CRSs for antenna ports 0, 1, 2, and 3, respectively, and REs expressed by ‘D’ denote the positions of DRSs.

### Demodulation Reference Signal (DMRS)

A DMRS is an RS defined for the purpose of causing a UE to perform channel estimation for a PDSCH. The DMRS may be used in transmission ports 7, 8, and 9. Initially, the DMRS has been defined for a single layer of antenna port 5 and, thereafter, use of the DMRS has been extended to spatial multiplexing of a maximum of 8 layers. As can be appreciated from its other name UE-specific RS, the DMRS is transmitted only for one specific UE. Therefore, the DMRS may be transmitted only in an RB in which a PDSCH for the specific UE is transmitted.

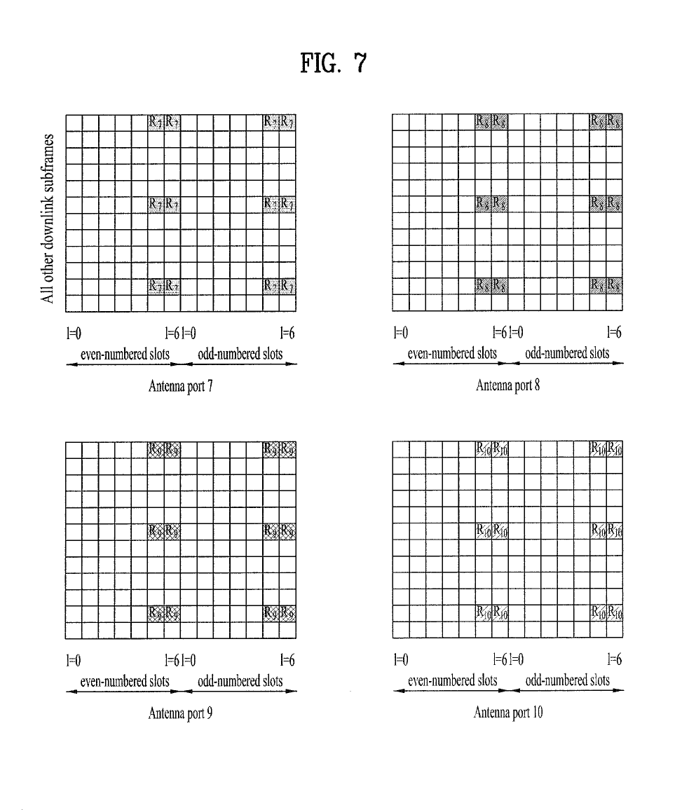

The DMRS for up to 8 layers are generated as follows. The DMRS may be transmitted by mapping a reference-signal sequence r(m) generated by Equation 5 to complex-valued modulation symbols a_{k,l}^{(p)} according to Equation 6. FIG. 7 illustrates antenna ports 7 to 10 as a result of mapping the DMRS to a resource grid on a subframe in the case of a normal CP according to Equation 2.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 12 {N}_{RB}^{max , DL} - 1 & normal CP \\ 0 , 1 , … , 16 {N}_{RB}^{max , DL} - 1 & extended CP\end{matrix} \qquad [ Equation 5 ]$$

where r(m) denotes an RS sequence, c(i) denotes a pseudo random sequence, and N_{RB}^{max,DL} denotes the maximum number of RBs of DL bandwidth.

$${a}_{k , l}^{( p )} = {w}_{p} ( {l}^{′} ) \cdot r ( 3 \cdot {l}^{′} \cdot {N}_{RB}^{max , DL} + 3 \cdot {n}_{PRB} + {m}^{′} ) \\ {w}_{p} ( i ) = \{ \begin{matrix}{\overline{w}}_{p} ( i ) & ( {m}^{′} + {n}_{PRB} ) mod 2 = 0 \\ {\overline{w}}_{p} ( 3 - i ) & ( {m}^{′} + {n}_{PRB} ) mod 2 = 1\end{matrix} \\ k = 5 {m}^{′} + {N}_{sc}^{RB} {n}_{PRB} + {k}^{′} \\ {k}^{′} = \{ \begin{matrix}1 & p ∈ \{ 7 , 8 , 11 , 13 \} \\ 0 & p ∈ \{ 9 , 10 , 12 , 14 \}\end{matrix} \\ l = \{ \begin{matrix}{l}^{′} mod 2 + 2 & for special subframe configurations 3 , 4 , 8 , and 9 \\ {l}^{′} mod 2 + 2 + 3 [ {l}^{′} \text{/} 2 ] & for special subframe configurations 1 , 2 , 6 , and 7 \\ {l}^{′} mod 2 + 5 & for non \text{-} special subframes\end{matrix} \\ {l}^{′} = \{ \begin{matrix}0 , 1 , 2 , 3 & for {n}_{s} mod 2 = 0 and special subframe configurations 1 , 2 , 6 , and 7 \\ 0 , 1 & for {n}_{s} mod 2 = 0 and special subframe configurations orther than 1 , 2 , 6 , and 7 \\ 2 , 3 & for {n}_{s} mod 2 = 1 and special subframe configurations orther than 1 , 2 , 6 , and 7\end{matrix} \\ {m}^{′} = 0 , 1 , 2 \qquad [ Equation 6 ]$$

As can be seen from Equation 6, an orthogonal sequence w̅ₚ(i) as illustrated in Table 5 is applied to the RS sequence according to antenna port during mapping to a complex modulation symbol.

TABLE 5

| Antenna port ^{p} | [ w̅ₚ(0) w̅ₚ(1) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

A UE may perform channel estimation using a DMRS by a different method according to a spreading factor (2 or 4). Referring to Table 1, since orthogonal sequences are repeated in the form of [a b a b] in antenna ports 7 to 10, a spreading factor is 2 and, in antenna ports 11 to 14, the spreading factor is 4. If the spreading factor is 2, the UE may perform channel estimation through time interpolation after despreading a DMRS of the first slot and a DMRS of a second slot to spreading factor 2. When the spreading factor is 4, the UE may perform channel estimation by simultaneously despreading DMRSs in an entire subframe to spreading factor 4.

The above-described channel estimation according to the spreading factor can obtain gain caused by application of time interpolation in high mobility and obtain gain in a decoding time caused by the possibility of despreading to a DMRS of the first slot, when the spreading factor is 2. In addition, when the spreading factor is 4, more UEs or ranks can be supported.

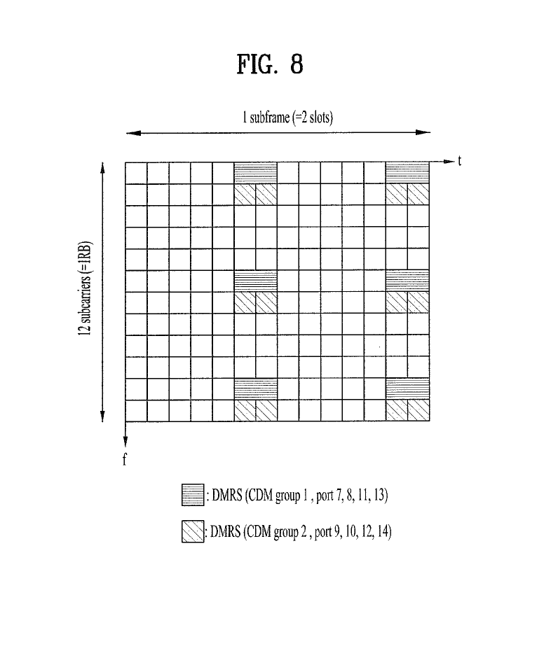

FIG. 8 will now be described in terms of DMRS overhead. FIG. 8 illustrates mapping in a subframe of DMRSs for antenna ports 7 to 14. As illustrated in FIG. 8, there are code division multiplexing (CDM) group 1 (or a first antenna port set) and CDM group 2 (or a second antenna port set) according to a DMRS mapping position in a resource grid. On REs corresponding to CDM group 1, DMRSs are transmitted through antenna ports 7, 8, 11, and 13 and, on REs corresponding to CDM group 2, DMRSs are transmitted through antenna ports 9, 10, 12, and 14. That is, DMRSs are transmitted on the same REs through antenna ports included in one CDM group. If DMRSs are transmitted using only antenna ports corresponding to CDM group 1, resources necessary for DMRSs are 12 REs, that is, DMRS overhead is 12 REs. Similarly, when antenna ports corresponding to CDM group 2 are used, DMRS overhead is 24 REs.

In an LTE system after Release 11, an enhanced-PDCCH (EPDCCH) is considered as a solution to PDCCH capacity shortage caused by coordinated multi-point (CoMP) transmission and multi-user (MU)-MIMO and to PDCCH performance deterioration caused by inter-cell interference. In the EPDCCH, DMRS based channel estimation can be performed to acquire precoding gain etc. as opposed to a conventional CRS based PDCCH. A plurality of physical resource block (PRB) pairs in the entire DL bandwidth may be configured for EPDCCH transmission. One PRB pair may include four enhanced CCEs (eCCEs) each having 4 enhanced REGs (eREGs). EPDCCHs may be classified into localized EPDCCHs and distributed EPDCCHs according to resource allocation type.

In the localized EPDCCHs, EPDCCHs may be transmitted in units of an eCCE and an antenna port may be configured on each eCCE. In the distributed EPDCCHs, EPDCCH transmission may be performed by configuring one eCCE with eREGs belonging to different PRB pairs and an antenna port may be configured on each eREG. A plurality of eCCEs may be used for one EPDCCH (or DCI) transmission according to an aggregation level (e.g. 1, 2, 4, or 8 (16)). For example, one DCI (format) may be transmitted using one eCCE at an aggregation level of 1 and one DCI may be transmitted using two eCCEs at an aggregation level of 2. Since an antenna port is configured on each eCCE which is a resource unit for EPDCCH transmission in a PRB pair (e.g. antenna ports 7, 8, 9 and 10 are respectively configured with respect to four eCCEs) as described earlier, if the aggregation level is 2 or more, the case in which an EPDCCH for one UE uses two or more antenna ports may occur. In addition, even if two pieces of DCI (e.g. DCI for DL assignment and DCI for UL grant) are transmitted to one UE, this may correspond to the case in which an EPDCCH for one UE uses two or more antenna ports.

In this case, the present invention proposes that the same precoding be applied to data/signals transmitted in prescribed resource sets (e.g. eCCEs, PRB pairs, or PRB pair sets).

Then, a UE may mitigate a noise component that hinders channel estimation by integrating energy transmitted by different antenna ports. This operation may be effective especially when resources constituting the same EPDCCH are extracted from the same PRB pair or from the same RBG or when the distance between two RBs is less than a predetermined distance. This is because channel estimation performance may deteriorate according to a frequency selective feature of a channel when it is assumed that the same precoding is performed with respect to DMRSs of a frequency region separated by a significant distance. Even though the same EPDCCH is transmitted through a plurality of RBs or a plurality of subsets using different DMRS ports, if the above-described predetermined requirements are satisfied, the UE can perform effective EPDCCH demodulation by performing channel estimation under the assumption that the same precoding is still carried out even in different DMRS ports.

In other words, the same precoding is applied to signals transmitted in different resource sets (eCCEs, PRB pairs, etc.) under specific conditions (e.g. when one EPDCCH (or DCI) is transmitted using contiguous resource sets) (in this case, port numbers may be equal or different) and the UE performs channel estimation by the same method for performing PRB bundling with respect to the resource sets (hereinafter, this will be referred to as resource-set bundling). In this case, if different ports are assigned to different resource sets, a method for performing channel estimation with respect to all resource sets in which the same EPDCCH is transmitted through the respective ports and combining channel estimated results is used or, if the same port is assigned to different resource sets, a method for performing channel estimation with respect to all resources using all DMRSs present in the resource sets may be used. Alternatively, even if different ports are used, channel estimation may be performed using all DMRSs without distinguishing ports after descrambling.

The case in which the above proposal of the present invention is applied may be broadly divided into three examples. While the following three examples will be described focusing upon the case in which one EPDCCH (or DCI message) is transmitted by a plurality of resource sets and/or a plurality of antenna ports, these may include the case in which a plurality of DCI messages (e.g. DL assignment and UL grant) for the same UE is transmitted. The first example is when an EPDCCH for a UE is transmitted through resource sets having different antenna ports in one PRB pair, the second example is when an EPDCCH for a UE is transmitted through resource sets having different antenna ports in different PRB pairs, and the third example is when an EPDCCH for a UE is transmitted through resource sets having the same antenna port in different PRB pairs. Here, resource sets may be eCCEs which are a resource unit for EPDCCH transmission in localized EPDCCH transmission.

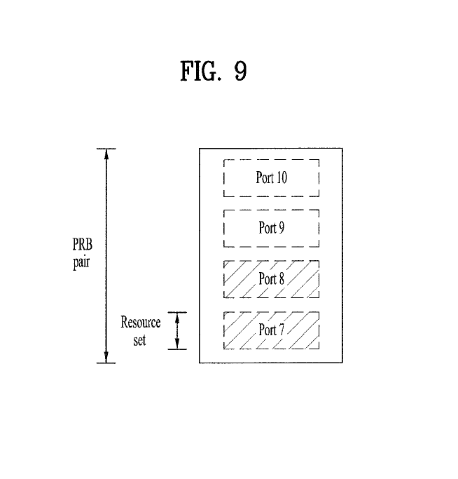

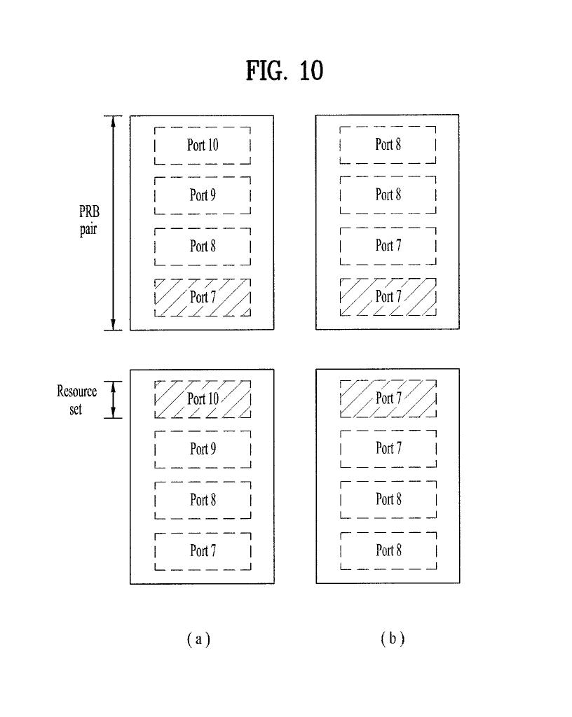

Hereinafter, the above-described proposal of the present invention for the above three examples will be described in detail with reference to FIGS. 9 and 10.

FIG. 9 is a view for explaining the case in which an EPDCCH for a UE is transmitted through a set having different antenna ports in one PRB pair.

Referring to FIG. 9, it may be appreciated that one PRB pair is composed of four resource sets, that is, four eCCEs. While it is assumed that resource sets are divided through frequency division multiplexing (FDM), resource sets may be differentiated by other schemes (e.g. time division multiplexing (TDM), FDM+TDM, interleaving, etc.). In FIG. 9, shaded resource sets may be used to transmit one DCI. In other words, FIG. 9 exemplarily illustrates localized EPDCCH transmission at an aggregation level of 2. In addition, the shaded resource sets may indicate that resource-set bundling is performed, that is, the same precoding is applied to data/signals transmitted to the resource sets. In the above example, while the resource sets in which bundling is performed are contiguous in the frequency domain, the resource sets may be non-contiguous in the frequency domain.

Further, in FIG. 9, since the same precoding is applied to ports 7 and 8 when different resource sets in one PRB pair transmit one EPDCCH (or DCI), resource-set bundling enables channel estimation for plural resource sets using only one of ports 7 and 8. Alternatively, a channel coefficient in each resource may be calculated by averaging a channel coefficient calculated using port 7 and a channel coefficient calculated using port 8. As an alternative, if ports 7 and 9 are bundled, a UE may perform channel estimation using 24 DMRS REs.

A network or an eNB may indicate whether resource-set bundling is performed through RRC signaling for resource-set bundling for the UE. That is, the network or the eNB indicates that the same precoding is applied to different resource sets. Since signaling for resource-set bundling is desirably performed when an aggregation level is 2 or more in localized EPDCCH transmission, if resource-set bundling is signaled, the UE may interpret this as a command indicating that resource-set bundling is applied with respect to an aggregation level of 2 or more.

Performance of resource-set bundling may be changed by the distance between resource sets in the frequency domain in which bundling is performed and by transmission mode. Accordingly, for resource utilization between multiple users, in the case of increase or decrease in the distance between resource sets in which one DCI is transmitted in the frequency/time domain or in the case of a transmission mode incapable of using bundling, it may be configured to perform resource-set bundling only in a specific candidate, a specific aggregation level, or a specific frequency/time domain. To this end, the network/eNB may signal a field (e.g. a 1-bit flag per candidate/aggregation level) capable of indicating whether bundling for each case is performed to a UE. When a large number of resource sets as at an aggregation level of 4 or 8 is used to transmit one DCI, the distance between resource sets in the frequency domain may increase and this may serve as a factor deteriorating bundling performance. In addition, when random beamforming (or precoder cycling) which may be applied to reduce beamforming performance deterioration caused by inaccurate CSI reporting from the UE is used or when operation is performed in diversity mode rather than beamforming mode in consideration of fallback operation at a high aggregation level (e.g. 4, 8, etc.), it is desirable that channel estimation be performed in each resource set through an allocated port without using bundling.

Accordingly, for efficient bundling and beamforming and to reduce signaling overhead, it may be assumed that resource-set bundling for a specific aggregation level (e.g. 4, 8, etc.) is not performed even without additional signaling or even when signaling indicating that bundling should be performed is transmitted. In addition, scheduling considering a channel state and load balance may be performed by signaling a subframe set in which bundling is performed in the time domain or signaling a time period in which bundling is performed.

FIG. 10 illustrates EPDCCH transmission for a UE through resource sets having different antenna ports (FIG. 10(a)) or the same antenna port (FIG. 10(b)) in different PRB pairs. That is, the same precoding may be applied to data/signals transmitted through shaded resource sets in FIG. 10. In addition, a shaded resource set in a PRB pair of an upper side of each case in FIG. 10 and a shaded resource set in a PRB pair of a lower side of each case of FIG. 10 in each case may be for different pieces of DCI. In other words, when two pieces of DCI (e.g. DCI for DL assignment and DCI for UL grant) are transmitted for one UE, the same precoding may be applied to resource sets for the two pieces of DCI. Bundling for transmission of different pieces of DCI for the same UE may be applied even to FIG. 9. For example, in FIG. 9, when DL assignment is transmitted in the resource set to which antenna port 7 is allocated and UL grant is transmitted in the resource set to which antenna port 8 is allocated, the UE may assume that the same precoding is applied by RRC signaling or by a condition indicating that a plurality of pieces of DCI is to be transmitted within a predetermined region. That is, channel estimation and demodulation may be performed with respect to the respective DCI messages using antenna ports 7 and 8.

As in FIG. 9, the network or the eNB may indicate whether resource-set bundling is performed to the UE through RRC signaling. (As illustrated in FIG. 10, if PRB pairs in which an EPDCCH for one UE is transmitted are contiguous in the frequency domain, the UE may recognize that bundling should be performed without any signaling). In this case, referring to FIG. 10(a) for example, during channel estimation for an EPDCCH transmitted through two resource sets, the UE may calculate a channel coefficient only with respect to one of two antenna ports. Alternatively, the UE may perform channel estimation by calculating channel coefficients for the two antenna ports and averaging the channel coefficients. In FIG. 10(b), since DCI is transmitted in resource sets through the same antenna port, the UE may perform channel estimation only with respect to antenna port 7. However, in FIG. 10(b), the number of DMRS REs used for channel estimation may increase. That is, a DMRS belonging to one PRB pair may be used for channel estimation of another PRB pair.

Meanwhile, while the PRB pairs are contiguous in the frequency domain in FIG. 10, the PRB pairs may be separated by a predetermined distance in the frequency domain unlike FIG. 10. When PRB pairs each including two pieces of DCI are separated by a significant distance in the frequency domain, if channel estimation is performed using an antenna port for one resource set as described above, channel state may not be sufficiently reflected. Accordingly, when bundling is performed (when the same precoding is applied in terms of an eNB), the distance between the PRB pairs may be restricted to a preset value or less in the frequency domain.

While the above description has mainly been given focusing upon localized EPDCCH transmission, the same may be applied even to distributed EPDCCH transmission by the same/similar logic. Notably, in distributed EPDCCH transmission, since one DCI is distributively transmitted in multiple PRB pairs and the PRB pairs may be separated by a predetermined distance or more in the frequency domain for frequency selectivity, it is necessary to signal whether to perform bundling in order to obtain bundling gain. Alternatively, bundling may be performed when PRB pairs belong to a predetermined region (frequency/time) and the predetermined region may be preset or may be determined through RRC signaling.

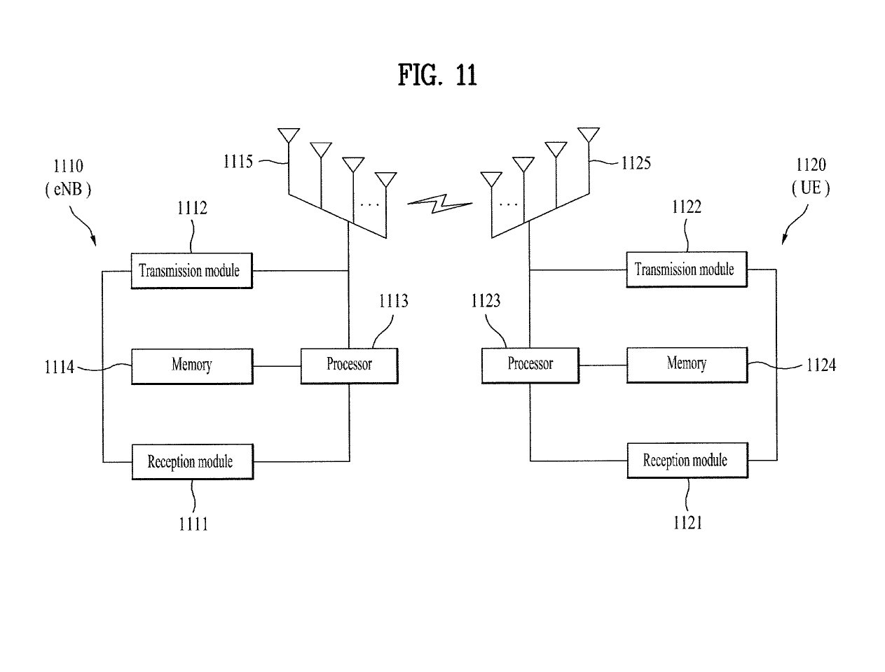

FIG. 11 is a block diagram of a transmission point and a UE according to an embodiment of the present invention.

Referring to FIG. 11, a transmission point 1110 according to the present invention may include a reception module 1111, a transmission module 1112, a processor 1113, a memory 1114, and a plurality of antennas 1115. The transmission point 1110 supports MIMO transmission and reception through the plural antennas 1115. The reception module 1111 may receive signals, data, and information on UL from the UE. The transmission module 1112 may transmit signals, data, and information on DL to the UE. The processor 1113 may control overall operation of the transmission point 1110.

The processor 1113 of the transmission point 1110 according to an embodiment of the present invention may process operations necessary for above-described measurement reporting, handover, random access, etc.

The processor 1113 of the transmission point 1110 may process information received by the transmission point 1110 or information to be transmitted from the transmission point 1110. The memory 1114 may store processed information for a predetermined time and may be replaced with a component such as a buffer (not shown).

Referring to FIG. 11, a UE 1120 may include a reception module 1121, a transmission module 1122, a processor 1123, a memory 1124, and a plurality of antennas 1125. The UE 1120 supports MIMO transmission and reception through the plural antennas 1125. The reception module 1121 may receive signals, data, and information on DL from the transmission point. The transmission module 1122 may transmit signals, data, and information on UL to the transmission point. The processor 1123 may control overall operation of the UE 1120.

The processor 1123 of the UE 1120 according to an embodiment of the present invention may process operations necessary for above-described measurement reporting, handover, random access, etc.

The processor 1123 of the UE 1120 may process information received by the UE 1120 or information to be transmitted from the UE 1120. The memory 1124 may store processed information for a predetermined time and may be replaced with a component such as a buffer (not shown).

The above transmission point and the UE may be configured to implement the foregoing embodiments independently or implement two or more of the embodiments simultaneously. For clarity, a repeated description will be omitted herein.

The description of the transmission point 1110 in FIG. 11 may apply to a relay node as a DL transmission entity or a UL reception entity and the description of the UE 1120 in FIG. 11 may apply to the relay node as a DL reception entity or a UL transmission entity.

The above-described embodiments of the present invention may be achieved by various means, for example, hardware, firmware, software, or a combination thereof.

In a hardware configuration, the methods according to the embodiments of the present invention may be achieved by one or more application specific integrated circuits (ASICs), digital signal processors (DSP), digital signal processing devices (DSDPs), programmable logic devices (PLDs), field programmable gate arrays (FPGAs), processors, controllers, microcontrollers, microprocessors, etc.

In a firmware or software configuration, the methods according to the embodiments of the present invention may be implemented in the form of a module, a procedure, a function, etc. Software code may be stored in a memory unit and executed by a processor. The memory unit is located at the interior or exterior of the processor and may transmit and receive data to and from the processor via various known means.

The detailed description of the exemplary embodiments of the present invention is given to enable those skilled in the art to realize and implement the present invention. While the present invention has been described referring to the exemplary embodiments of the present invention, those skilled in the art will appreciate that many modifications and changes can be made to the present invention without departing from the scope of the present invention. For example, the constructions of the above-described embodiments of the present invention may be used in combination. Therefore, the present invention is not intended to limit the embodiments disclosed herein but is to give a broadest range matching the principles and new features disclosed herein.

The present invention may be embodied in other specific forms than those set forth herein without departing from the spirit and essential characteristics of the present invention. The above description is therefore to be construed in all aspects as illustrative and not restrictive. The scope of the invention should be determined by reasonable interpretation of the appended claims and all changes coming within the equivalency range of the invention are intended to be within the scope of the invention. The present invention is not intended to limit the embodiments disclosed herein but is to give a broadest range matching the principles and new features disclosed herein. In addition, claims that are not explicitly cited in each other in the appended claims may be presented in combination as an embodiment of the present invention or included as a new claim by subsequent amendment after the application is filed.

### INDUSTRIAL APPLICABILITY

The above-described embodiments of the present invention are applicable to various mobile communication systems.

1. A method for transmitting control information by a base station in a wireless communication system, the method comprising:
transmitting an enhanced physical downlink channel (EPDCCH) for a user equipment using at least one or more physical resource block (PRB) pairs among a plurality of PRB pairs for EPDCCH transmission,
wherein the plural PRB pairs includes a plurality of resource units for EPDCCH transmission, to which antenna ports are respectively allocated, and
if the EPDCCH for the user equipment is transmitted using at least two or more resource units in the at least one or more PRB pairs, the same precoding is applied to signals to be transmitted in the two or more resource units.

2. The method according to claim 1, wherein the at least two or more resource units in which the EPDCCH for the UE is transmitted are included in one PRB pair and different antenna ports are allocated to the at least two or more resource units.

3. The method according to claim 2, wherein the at least two or more resource units included in the one PRB pair are for one downlink control information (DCI).

4. The method according to claim 3, wherein the number of resource units in which the EPDCCH for the user equipment is transmitted is determined according to an aggregation level.

5. The method according to claim 2, wherein, if the number of resource units in which the EPDCCH for the user equipment is transmitted is greater than a preset number, the base station applies precoding unique to each signal to be transmitted in resource units of the preset number or more.

6. The method according to claim 2, wherein only one of the different antenna ports is used for channel estimation of the user equipment.

7. The method according to claim 2, wherein, if all of the different antenna ports are used for channel estimation of the user equipment, channel estimation is performed by an average of channel estimation values for the different antenna ports.

8. The method according to claim 2, wherein, if all of the different antenna ports are used for channel estimation of the user equipment, all of demodulation reference signal reference elements related respectively to the different antenna ports are used for channel estimation.

9. The method according to claim 1, wherein the at least two or more resource units in which the EPDCCH for the user equipment is transmitted are included in different PRB pairs and different antenna ports are allocated to the at least two or more resource units.

10. The method according to claim 9, wherein the at least two or more resource units included in the different PRB pairs are for at least two or more pieces of downlink control information (DCI).

11. The method according to claim 10, wherein the at least two or more pieces of DCI include DCI for uplink information transmission and DCI for downlink information transmission.

12. The method according to claim 9, wherein, if the different PRB pairs are separated by a preset value or more in a frequency domain, the base station applies precoding unique to each signal to be transmitted in two or more resource units.

13. The method according to claim 9, wherein only one of the different antenna ports is used for channel estimation of the user equipment.

14. The method according to claim 9, wherein, if all of the different antenna ports are used for channel estimation of the user equipment, channel estimation is performed by an average of channel estimation values of the different antenna ports.

15. The method according to claim 8, wherein, if all of the different antenna ports are used for channel estimation of the user equipment, all of demodulation reference signal reference elements related respectively to the different antenna ports are used for channel estimation.

16. The method according to claim 1, wherein signaling indicating whether to apply the same precoding is transmitted to the user equipment through higher layer signaling.

17. A base station in a wireless communication system, the base station comprising:
a transmission module; and
a processor,
wherein the processor transmits an enhanced physical downlink channel (EPDCCH) for a user equipment using at least one or more physical resource block (PRB) pairs among a plurality of PRB pairs for EPDCCH transmission, the plural PRB pairs includes a plurality of resource units for EPDCCH transmission, to which antenna ports are respectively allocated, and if the EPDCCH for the user equipment is transmitted using at least two or more resource units in the at least one or more PRB pairs, the same precoding is applied to signals to be transmitted in the two or more resource units.
